(19) United States
(12) Patent Application Publication
(10) Pub. No.: US 2004/0167652 A1
(43) Pub. Date: Aug. 26, 2004

(54) System for assisting planning of work allocation utilizing visual display screen

(76) Inventor: Tatsuhisa Ishii, Aichi (JP)

Correspondence Address: Oliff & Berridge, Suite 500, 277 South Washington Street, Alexandria, VA, 22314, US

(21) Appl. No.: 10/480,772

(22) PCT Filed: Jul. 1, 2002
(86) PCT No.: PCT/JP02/06657

(30) Foreign Application Priority Data
Jul. 3, 2001 (JP) 2001-202805

(51) Int. Cl. G06F 17/60

(52) U.S. Cl. 700/100; 705/9

(57) ABSTRACT

The invention vigorously supports a process of allocating tasks numbering several thousand to units numbering several hundred and allows a streamlined task assignment to be obtained in a short time.

The computer system of the invention comprises the following:

Task list storing memory 2 stores, on a by-task basis, task times, and task location within a product.

Unit list storing memory 4 stores, on a by-unit basis, tasks allocated to the unit and task order within the unit.

Walking time calculation means 6 calculates walking time of a worker from the task order within the unit and task location within the product.

Task assignment visual display screen displaying means 8 displays a visual display screens about task assignment in which task times and walking times are displayed along the Y-axis in accordance with the task order within a unit at a location corresponding to the unit on the screen in which the units are arranged along the X-axis.

Sifting means 30 allows a planner to designate and shift a certain task in the task assignment visual display screen.

Updating means 32 updates the contents stored in the unit list storing means 4 in accordance with the result of shift by the shifting means 30.

### FIELD OF THE INVENTION

For example, in an automobile assembly plant, parts numbering several thousand are used and tasks numbering several thousand are performed to produce an automobile. In normal mass-production factories, several thousand tasks are divided among workers numbering several hundred to assemble a final product such as an automobile. In this specification, a group of tasks allocated to a single worker shall be referred to as a unit. In standard mass-production factories, a plurality of tasks is divided into a plurality of units, and each unit is assigned to each worker. Products are repeatedly produced through a plurality of units. In such production methods, the group of tasks to be allocated to each unit must be decided appropriately. If the task assignment to each unit is decided in a streamlined manner, high-quality products can be easily and efficiently produced, while the task assignment that is not streamlined brings about difficulties in operations and waste of time.

The invention relates to a technology for planning the streamlined task assignment in a short amount of time.

### BACKGROUND TECHNOLOGY

A variety of issues must be taken into account when allocating tasks numbering several thousand to units numbering several hundred. For example:

(1) Total task time in each unit must be almost uniform across units. If it is not uniform, there is difficulty in those units requiring long task time and waste of time in those units requiring short task time.

(2) Tasks group should not be allocated into a unit in an unordered manner—it is preferable to associate tasks with respect to a function required for the product. In the case of automobiles, it is preferable that, for example, the assembly of an exhaust-related parts group be fully completed with one or a plurality of units, and that the assembly of a braking-related parts group be fully completed with another unit or another plurality of units. By doing so, worker morale is boosted, an inspection unit can be allocated in a streamlined manner, and high-quality products can be continuously produced in a stable manner.

(3) The assembling order of the parts groups classified by their functions is important. For instance, the order of assembly of the exhaust-related parts group, braking-related parts group, steering-related parts group, and transmission related parts group, etc. must be decided appropriately. The determination of the optimal order of assembly requires product knowledge and variety know-how regarding assembly tasks.

(4) There are some tasks restricted in their order with the other tasks. For example, there is a task that must be performed after another task is completed. There is also a group of two or more tasks that must be performed in the same unit.

(5) There are tasks that are restricted in terms of locations within a production line where the tasks are performed due to reasons associated with the production facilities.

(6) In the case of a large product such as an automobile, the task locations within the product also become important. If a large number of tasks to be performed at different task locations within the product are assigned into a single unit, the unit requires long walking time.

The process of allocating several thousand tasks to several hundred units while considering the above matters is extremely complicated and the present data processing technologies are unable to satisfactorily meet the requirements. At present, task assignment is decided by an individual skill of a veteran task assignment planner, and trial and error are repeated to finalize the task assignment.

### SUMMARY OF THE INVENTION

The process of determining task assignment through repeated trial and error in a manner largely dependent on the individual skill of the veteran task assignment planner is time consuming, and a long time is required at the stage of preparing for production. The invention provides with a technology that vigorously supports the process of determining task assignment and allows streamlined task assignment to be obtained in a short time.

The device realized in accordance with the invention supports the process of determining task assignment. The device supports the process of determining which tasks are combined to make a group and assigned to a unit. A group of tasks assigned to each unit is performed in each unit by each worker and products are successively produced through a plurality of units. The support device realized in accordance with the invention is composed with a computer system. The computer system of the invention comprises a storage device, a display device, a display control device, and a computing device.

One example computer system of the invention, the concept of which is shown schematically in FIG. 1, comprises the following means:

Task list storage means 2; which stores tasks to be assigned and performed, task time of each task, and task location within the product of each task.

Unit list storage means 4; which stores tasks group allocated to each unit and task order of each task within the tasks group allocated to the unit. Tasks group and the task order of each task are stored with respect to each unit.

Walking time calculation means 6; which calculates the walking time of workers from the task order stored in the unit list storage means 4 and task location within the product stored in the task list storage means 2.

Task assignment visual display screen means 8; which displays a visual display screen about task assignment in which task time and walking time are integrally displayed along the Y-axis in accordance with the task order within the unit. The units are arranged in the order of performance along the X-axis. The product under manufacture is brought through units in the order arranged along the X-axis.

Shifting means 30; which allows a planner to designate and shift a certain task in the task assignment visual display screen being displayed.

Updating means 32; which updates the contents stored in the unit list storage means 4 in accordance with the results of shift conducted by the shifting means 30.

According to the computer system, the tasks group and order of implementation thereof in each unit are arranged and stored in the unit list storage means 4. As the task location within the product are stored in the task list storage means 2, the walking time of the worker in charge of the unit during the completion of the tasks allocated the unit can be calculated. As a result, the task list storage means 2, unit list storage means 4 and the working time calculation means 6 enables the task assignment visual display screen to be displayed.

In the task assignment visual display screen 8, units are shown along the X-axis in the order of the performance, and time is presented along the Y-axis. Task time and walking time are integrally displayed along the Y-axis in the order of the performance within each unit at the location corresponding to each unit on the display screen 8.

The planner, by referring to the task assignment visual display screen, can promptly grasp the degree of uniformity and other properties of the time required for each unit and specify any necessary corrections.

The computer system allows the planner to designate and shift a certain task within the task assignment visual display screen. The following example is shown in FIG. 1: The tasks group allocated to “unit 1” is too large and requires a time longer than the task time of “unit 2”, so the planner specifies “task 3” (arrow 16 shows the designation of task 3) and shifts it to the location following “task 7” of “unit 2” (arrow 18 shows the shift of the task 3).

When the planner shifts task in the task assignment visual display screen with the shifting means 30 in the computer system, the updating means 32 is activated and updates the content stored in the unit list storage means 4 in accordance with the result of shift. When the content stored in the unit list storage means 4 is updated, walking time is recalculated, and the task assignment visual display screen is updated. Reference symbol 44 shows an example of a task assignment visual display screen that has been updated after the shift—“task 3” that was in “unit 1” has been moved to the location following “task 7” of “unit 2”, and a newly calculated walking time is shown.

The planner can change task assignment that is not streamlined to a streamlined task assignment while referring to the task assignment visual display screen, so the streamlined task assignment can be achieved in a short time. At this time, task assignment is planned in consideration even of walking time, which enables a task assignment plan of high accuracy.

As FIG. 1 schematically shows, the computer system preferably further comprises a inter-task restrictive condition storage means 36 that stores restrictive conditions among tasks, and a warning means 40 for issuing a warning when the result of shift designated by shifting means 30 violates one of the restrictive conditions.

There are some tasks restricted in their order with other tasks. For example, there is a task that cannot be performed unless another task has been completed in advance, and there is a group of two or more tasks that must be performed in the same unit. When such restrictive conditions are stored in the inter-task restrictive condition storage means 36, a warning is issued when the planner mistakenly correct the task assignment in violation of the restrictive conditions, so no task assignment that violates the restrictive conditions is drafted.

It is preferable that the computer system further comprises a means for additionally displaying a symbol that indicates the inter-task restrictive condition among tasks in the task assignment visual display screen.

In FIG. 1, arrow 14 illustrates an example of the restrictive condition that “task 4 must be performed before task 8” and arrow 12 illustrates another example of the restrictive condition that “task 4 and task 5 must be performed in the same unit.” The graphical illustration of these restrictive conditions prevents the planner from mistakenly correcting the task assignment in violation of the restrictive conditions.

As schematically shown in FIG. 1, it is preferable that the computer system further comprises a task-unit restrictive condition storage means 38 storing restrictive conditions between task and unit. It is also preferable that the computer system further comprises a means that additionally displays production facility layouts 26 and 28 associated with the units shown in the task assignment visual display screen. The warning means 40 issues a warning when the result of the shift made by the shifting means 30 violates one of the restrictive conditions with respect to task and unit. There are tasks that are restricted in terms of the location within the production line where the tasks are performed due to reasons associated with the production facilities. In FIG. 1, an example is shown in which “task 6” is a task that uses a stationary facility 26, so “task 6” has a restrictive condition requiring it to be performed in “unit 2” (See arrow 24.).

When such restrictive conditions with respect to task and unit are stored in the task-unit restrictive condition storage means 38, a warning is issued when the planner mistakenly correct the task assignment so that a task is shift to a unit in which the task cannot be performed. Therefore no task assignment that violates the task-unit restrictive conditions is drafted.

It is preferable that the computer system further comprise, as is shown schematically in FIG. 1, a means for additionally displaying an illustration that shows a tact time (see line 46) on the task assignment visual display screen, and a means 42 for searching for the task list storage means 2 with a task time entered by the planner as a key and displaying searched tasks (tasks group) 52, 54, 56 that have task times near the task time entered. The tact time indicated by the line 46 is a given time to each unit. The tasks assigned to the unit should be completed within the tact time.

When an illustration that shows the tact time (see line 46) is additionally displayed on the task assignment visual display screen, the planner can easily recognize an excess or less time of the task assignment in pending with respect to the given tact time. In the case of FIG. 1, line 46 showing the tact time is displayed, so the planner can easily determine that waste time 48 would arise in “unit 2” when the illustrated task assignment is adopted.

In this situation, the planner can input the task time 48 to be wasted in the “unit 2” by the means 42 and cause the searching means 42 of the computer system to perform a search. The searching means 42 of the computer system searches for the task list storage means 2 and displays searched tasks group 52, 54, 56 having task times near the task time 48 input, so the planner can promptly learn candidates of tasks which may be appropriate to newly allocate to “unit 2”. In this manner, the task assignment with little waste time can be obtained in a short time.

It is preferable that the computer system, as schematically shown in FIG. 1, further comprises a means for switching to and displaying an integrated task assignment visual display screen 45 that integrates and displays the task times and walking times for each unit on the integrated task assignment visual display screen 45.

In the integrated display screen 45, walking times (indicated with diagonal lines) and task times (indicated without diagonal lines) are respectively integrated, separated, and displayed, and as such, the total walking time in a unit can promptly be ascertained visually. When the integrated task times are displayed on the lower side, the total net task time in a unit can promptly be ascertained visually.

As a result, the planner can correct or modify the task assignment while knowing the total walking time and total net task time in a unit and thereby avoid an un-streamlined task assignment in which worker's time is consumed on unnecessary walking.

There are many units, for example, in an automotive assembly plant—they number several hundred. This makes it difficult to display all the units in a single display device. If, as is schematically shown in FIG. 2, a means that displays task assignment visual display screen arranged continuously by using two or more display devices is added to the computer system, the problem is resolved. In this case, it is preferable that a means for referencing of other screens and a means of shifting tasks among multiple screens be provided with the display devices.

The computer system developed by the invention is new. This new computer system displays a task assignment visual display screen in which task times and walking times between tasks are integrally displayed along the Y-axis in accordance with task order within a unit at a location corresponding to the unit, wherein the units are arranged along the X-axis.

A screen visually displaying a task assignment became available due to the invention which created the new computer system. The task assignment planner can precede the process of assigning tasks to units while visually ascertaining task assignment under consideration, so the streamlined task assignment can be obtained in a short time.

Another creation of the invention is a program that displays a task assignment visual display screen in which task times and walking times between tasks are integrally displayed along the Y-axis in accordance with the task order within a unit at a location corresponding to the unit, wherein the units are arranged along the X-axis.

It is preferable that the computer system additionally displays an illustration 10 that shows a task time by its length in the Y-axis direction of a task not associated with a unit. As will be described in detail later, there is a method of planning task assignment in which a group of parts and tasks for an old product already in production is compared to a group of parts and tasks for a new product whose production will begin, in order to enhance the points of correspondence and difference so that task assignment for the new product can be planned while the similarities and differences with the old product are focused on.

In this situation, as is shown schematically in FIG. 1, the additional illustration 10, which indicates the task not associated with any unit, shows at a glance the tasks that should be allocated to the unit and greatly assists the planner to plan the task assignment draft. FIG. 1 shows an example in which the display screen shows that “task 9” has not yet been allocated to the unit, so the planner has specified “task 9” (see arrow 20) and allocated it to the “unit 1” (see arrow 22). As a result, the task assignment visual display screen indicated with 44 is updated.

It is preferable that the computer system additionally displays the production facility layouts 26, 28 in association with the units.

As illustrated in FIG. 1, when the production facility layouts 26, 28 are shown associated with the units on the task assignment visual display screen, the relationship between the unit and facility layout can be grasped at a glance, and restrictive conditions on unit and task are easy to comprehend. FIG. 1 illustrates an example in which the stationary facility 26 is situated in the location of execution of “unit 2”, and the “task 6”, which uses the stationary facility 26, must be performed in “unit 2”, so “task 6” is fixed to “unit 2”.

It is highly preferable that the computer system has a means that allows the planner to specify a certain task on the task assignment visual display screen and shift the specified task within the task assignment visual display screen.

If this is the case, the planner can improve task assignment while ascertaining at a glance the conditions of task assignment in consideration with the task assignment visual display screen and thereby obtain the streamlined task assignment in a short time.

It is often in modern mass-production factories that many kinds of products are made in mixed production rather than one kind of products being made sequentially. For instance, 100 items of “product 1” and 150 items of “product 2” may be made in one day.

The workload of each unit in the production line often changes depending on the kind of product. For example, “product 2” may require a higher workload in “unit 1” and a lower workload in “unit 2” and “product 1” may require a lower workload in “unit 1” and a higher workload in “unit 2”.

The streamlined task assignment must have little fluctuation in the workload in each unit not only between units, but also between product types.

It is thus preferable that the computer system, as shown in FIG. 3, is able to switch among the displays of task assignment visual display screens for certain products 62, 64 and an averaged task assignment visual display screen 60 that displays the weighted average task times and walking times per unit time for products group produced in mixed production.

The degree of fluctuation in the workload among units can be ascertained by referring to the averaged task assignment visual display screen 60, and the degree of fluctuation in the workload for individual products can be visually ascertained by referring to the task assignment visual display screens for certain products 62, 64. FIG.3 shows an example that there is a large workload fluctuation in unit 1 between the products 62 and 64, and there is no fluctuation in unit 2 between the products 62 and 64.

Another feature of the support device of this invention, as is schematically shown in FIG. 4, is that the device comprises a parts list storage means 70 that stores a plurality of parts lists, each list itemizing necessary parts in producing each kind of product. The support device further comprises a parts-assembly task master storage means 72 that stores, on a by-part basis, task for assembling the part, task time of the task, task location within the product of the task, and priority order of the part and task. The support device further comprises a unit list storage means 4 that stores, on a by-unit basis, tasks allocated to the unit and task order within the unit of each task. The support device further comprises a means 6 for calculating walking time of workers from the task order stored in the unit list storage means 4 and the task location stored in the parts-assembly task master storage means 72. The support device further comprises a means 74 for calculating, on a by-unit basis, total time of the task times and the walking times in the unit. The support device further comprises a means 76 for searching a task to be allocated to a unit and storing the searched task in the unit list storage means 4. The searching means 76 searches the task under the conditions that the priority orders of the tasks allocated to the single unit are all same and the total time of the unit is equal to or less than a specified time.

Because tasks for assembling a parts, the task times, and the task locations within the product are stored, on a by-part basis, in the parts-assembly task master storage means 72 of the computer system, once a list of the parts is obtained, the tasks needed for assembling the parts, the task times needed for completing the required tasks, and the task locations within the product at which tasks are performed can be learned.

Parts are closely related to function of the product. The research of the inventors revealed that it is preferable not to allocate tasks to a unit in an unordered manner but rather to associate tasks with respect to their function of the product. In the case of automobiles, it is preferable that the assembling tasks of an exhaust-related parts, for example, be fully completed with one or a plurality of units and that the assembling tasks of a braking-related parts, for example, be fully completed with another unit or another plurality of units. By doing so, worker morale is boosted, an inspection unit can be allocated in a streamlined manner, and high-quality products can be continuously produced in a stable manner. The order of assembling parts groups classified by their functions, which is called a priority order in this specification, is important. For instance, the assembling orders of the exhaust-related parts group, braking-related parts group, steering-related parts group, and transmission related parts group, etc. must be decided appropriately. When products are produced in an appropriate priority order, high-quality products can be produced without difficulty in operation or waste of time, while difficulty and waste arise when production occurs in another priority order. Much trial and error must be repeated before it becomes possible to determine the optimal priority order, which is a valuable know-how.

So when parts are classified by functions, the priority order of part and task can be determined in accordance with the classified functions of the parts. If the know-how teaches that an exhaust-related parts group should be assembled earlier than a braking-related parts group, then higher priority order is given to the exhaust-related parts and tasks. By giving appropriate priority order based on the established know-how, reasonable task assignment can be planned based on the know-how accumulated over the past. The task assignment thus planned enables well considered production activities and high-quality products are continuously produced in a stable manner.

As the priority orders of parts and tasks are stored in the parts-assembly task master storage means 72 of the computer system, tasks may be divided into groups. Each group includes tasks having same priority order. The number of tasks divided in each group decreases, and when the number of tasks decreases, task assignment resulting task time of each unit uniformly distributed among the units can be calculated automatically. As the computer system stores priority order based on broad classification by the function of parts, task assignment can be calculated automatically within a practical amount of time. The task assignment thus calculated utilizes know-how accumulated over the past.

Automatically calculated task assignment can be displayed on the task assignment visual display screen and be corrected by the planner. Using the task assignment that is automatically calculated as the starting point of corrections, the planner can obtain the streamlined task assignment in a short time.

When multiple kinds of products are made in a mixed production line, making large changes in tasks assigned to the same unit depending on kinds of products stops improvements of assembling skills of workers and makes it difficult to perform the assigned tasks efficiently. In such cases, it is better to work on parts common to different products in the same unit.

The invention also brings about a computer system that can meet this requirement. This computer system, shown schematically in FIG. 5, comprises an existing product unit list storage means 80 that stores, on a by-unit basis, parts used in the unit, tasks allocated to the unit, and task orders within the unit for products already in production. The system also comprises a new product parts list storage means 82 that stores parts for use in the new product for which production will start, The computer system also comprises a parts-assembly task master storage means 72 that stores, on a by-part basis, tasks for assembling the parts, task time of each task, task location within the product of each task, and priority order of each part and task. The computer system also comprises a means 84 that searches for the existing product unit list storage means 80 using as a key the parts stored in the new product parts list storage means 82 and determines the units in which the same part is used for producing one of the existing products and the new product. The searched units, common parts, common tasks and task order of each task are stored in the means 84. The computer system also comprises a means 86 for storing new parts not found by the means 84. The new parts here are not used for producing the existing products and newly introduced for the new product. The means 86 displays, by a part basis, task, task time, task location within the product, and priority order. The priority order is determined based on faction of the part and stored in the parts-assembly task master storage means 72.

The computer system is provided with a means 84 that searches for the existing-product unit list storage means 80 using as a key the parts stored in the new product parts list storage means 82 and determines the unit in which the part for the new product was already used for producing the existing products, so common parts, even when used in different products, can be worked on in the same unit.

When working with parts unique to the new product, the planner can obtain the tasks that must be newly allocated and information that must be learned in order to allocate those tasks, because the means 86 displays the tasks for the unique parts, task times, task locations within the new product, and the priority order.

The use of the computer system allows the visual display, at the start of planning task assignment, that illustrates task assignment already obtained for parts common to the existing products and new product. The system also displays, for parts unique to the new product, the tasks, task times, task locations within the product, and priority order of each unique part, so a task assignment not contradictive of the task assignment for existing products can be obtained in a short time.

Another computer system of the invention comprises a task list storage means 2 that stores task time of each task, a unit list storage means 4 that stores tasks allocated to the unit and the task order within the unit of each task, a means for displaying a task assignment visual display screen that integrally displays task times along the Y-axis direction in accordance with the task order within a unit at a location of the unit on a screen, the units being arranged along the X-axis, a means that allows a planner to specify and shift a certain task on the task assignment visual display screen, and a means for updating content stored in the unit list storage means 2 in accordance with the result of the shifting.

Moreover, the computer system—which displays a task assignment visual display screen in which task time is integrally displayed along the Y-axis in accordance with the task order within a unit at the location of the unit on a screen in which units are presented along the X-axis—is also a novel creation.

Also a creation of the invention is a program that displays a task assignment visual display screen in which task times are integrally displayed along the Y-axis in accordance with the task order within a unit at a location of the unit on a screen in which the units are presented along the X-axis.

According to the invention, the complex process of planning task assignment is vigorously supported, so the burden on the task planner is lessened, and a streamlined task assignment can be obtained in a short amount of time. The duration from the completion of product design to the start of mass production is significantly shortened, and production activities without difficulty or waste of resources can be undertaken.

### BRIEF DESCRIPTION OF THE DRAWINGS

FIG. 1 schematically shows a structure of the support device of the invention.

FIG. 2 shows a visual display screen displayed by a plurality of display devices arranged along a line.

FIG. 3 shows the switching between an averaged task assignment visual display screen and by-product task assignment visual display screens.

FIG. 4 schematically shows compositional features of the support device of the invention.

FIG. 5 schematically shows other compositional features of the support device of the invention.

FIG. 6 schematically shows the composition of the task time calculation device of the invention.

FIG. 7 illustrates the support device for planning task assignment of an embodiment of the invention as functional blocks.

FIG. 8 shows the network configuration of the support device for planning task assignment of an embodiment of the invention.

FIG. 9 shows an example of the content stored in the parts list.

FIG. 10 shows an example of the content stored in the parts-assembly task master.

FIG. 11 shows an example of the content stored in the task time master.

FIG. 12 shows an example of other content stored in the task time master.

FIG. 13 shows a display used for input when task time is being searched for and determined.

FIG. 14 illustrates an example of the priority in accordance of broadly classified functions.

FIG. 15 shows an example of task locations within a product.

FIG. 16 shows a map that is referred to by the walking time calculation means.

FIG. 17 shows partially expanded view of an example of the task assignment visual display screen.

FIG. 18 shows an example of the content stored in the unit list storing means.

FIG. 19(A) shows a visual display of a task assignment established in an existing product.

FIG. 19(B) shows an example of a visual display screen shown when a search is performed with parts for a new-product as a key.

FIG. 20 illustrates the selection and shift of a certain task in the visual display screen.

FIG. 21 shows an example of a warning displayed when the restrictive condition is violated as a result of the selection and shift of the certain task.

FIG. 22 shows a display used when search criteria such as task time are to be specified.

FIG. 23 shows an example of searched-out tasks displayed in tabular form.

FIG. 24 shows another screen that is referred to.

FIG. 25 shows examples of fluctuation in task times on a by-product basis and fluctuation in task time, on a by-unit basis, averaged for a product.

FIG. 26(A) to (C) show a comparison of a standard task assignment visual display, a visual display with walking times grouped together, and a visual display with net task times grouped together.

FIG. 27 shows an example of an animated display screen when tasks are performed according to a task assignment as planned.

FIG. 28 shows an example of an evaluation screen that evaluates the degree of completion of a task assignment.

FIG. 29 shows a processing routine employed when a task assignment is calculated automatically with the unit/task group searching means 124 for a newly installed production facility.

### PREFERRED EMBODIMENTS OF THE INVENTION

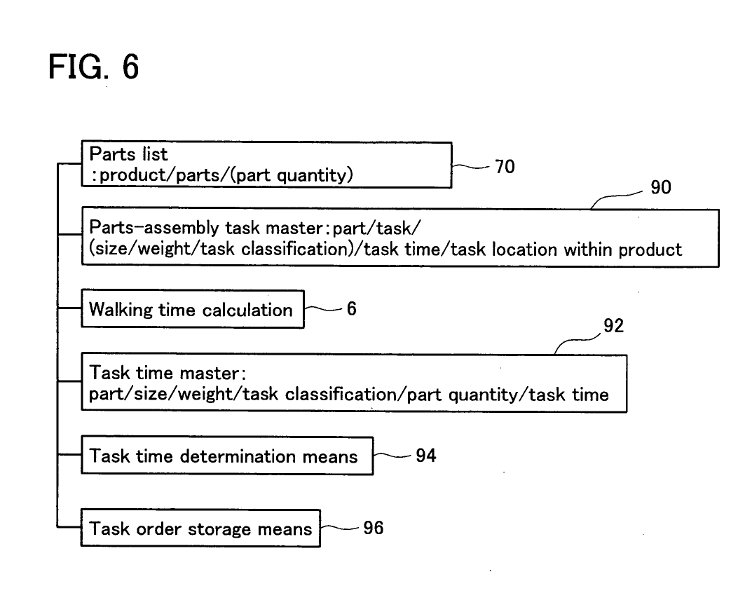

The invention can be practiced by using a computer system described below. The computer system, as schematically shown in FIG. 6, calculates task time of each task required for producing a product from a list of parts to be used in producing the product. The computer device of the invention comprises at least a storage unit and a computing unit.

One example computer device of the invention, as schematically shown in FIG. 6, comprises a parts list storage means 70 that stores a parts to be used in producing a product. The device further comprises a parts-assembly task master storage means 90 that stores, on a by-part basis, task for assembling the part and task time of the task. The device further comprises a means 94 that searches for the parts-assembly task master storage means 90 with the part stored in the parts list storage means 70 as a key and determines task time of a task for assembling the part.

When task assignment in mass-production activities is to be decided on, conventionally, a form was created for each unit of the mass production line. In this case, it was difficult to assemble a parts list and tasks lists for each unit, and it was extremely difficult to complete forms for every unit. According to this device, the parts-assembly task master storage means 90 is provided so that the tasks of assembling a part and the associated task times are stored by-part basis. As such, when a parts list for a product is completed through product design activity, necessary tasks and corresponding task times can be obtained from the parts list. As the tasks and corresponding task times necessary for producing the product are calculated from the parts list of the product, the process for calculating task time of each task is simplified, and the process of planning a task assignment can be started earlier.

Conventionally, the determination of task assignment for mass-production activities involved consideration of necessary tasks. The number of the necessary tasks is huge, so the duty of organizing the tasks list was difficult. According to this embodiment, a parts-assembly task master storage means 90 is provided so that the tasks of assembling parts and the associated task times are stored by-part basis. As such, when a list of parts to be used for producing a product is completed through product design activity, a list of tasks and a list of task times can be obtained from the parts list through the parts-assembly task master 90. And because the list of task times is determined from the parts list, task assignments can be drafted from the parts list.

Another computer device of the invention, as shown schematically in FIG. 6, comprises a parts list storage means 70 that stores parts to be used in producing a product, a parts-assembly task master storage means 90 that stores, on a by-part basis, task for assembling the part, task time of the task, and task location within the product of the task, a means 96 that stores a task order of the task within a unit, a means 94 that searches for the parts-assembly task master storage means 90 with the part stored in the part list storage means 70 as a key and determines task time of a task for assembling the part, and a means 6 for calculating worker walking time from the task order stored in the task order storage means 96 and the task location of the task stored in the parts-assembly task master storage means 90.

According to this computer device, the task time is determined and walking time is calculated from the parts list, the parts-assembly task master, and the task order data. Therefore, data on the task time, walking time, and other aspects necessary for planning a task assignment can be obtained from the parts list. Although the content stored in the task order storage means 96 cannot be finalized unless task assignment is decided on, it can be provisionally stored in the process of drafting a task assignment, and this provisional storage vigorously supports the process of planning the task assignment through the computer system.

Another computer device of the invention, as shown schematically in FIG. 6, comprises a parts list storage means 70 that stores parts to be used in producing a product, a parts-assembly task master storage means 90 that stores, on a by-part basis, task classification of a task corresponding to the part, a task time master storage means 92 that stores task time for size and/or weight of part and task classification. The device further comprising a means 94 for searching for the task time master storage means 92, using as keys, the part stored in the parts list storage means 70 and the task classifications searched from the parts-assembly task master storage means 90 for that part. The means 92 calculates task time from the parts list.

In the case of this computer device, task classification (types of tasks such as a choice among taking out, setting, fastening, joining or inserting part etc.) associated with the part are stored in the parts-assembly task master storage means 90 instead of task times for individual tasks being stored. Task times corresponding to size of part, weight of part and task classification of part are stored in the task time master storage means 92. Thus, when a part is determined from the parts list 70, task time of the task corresponding to the part is determined from the parts-assembly task master storage means 90 and the task time master storage means 92.

According to this computer device, a database for designating task times can be relatively easily developed from the parts list.

And even when there is a plurality of parts, such as two, it is not the case that twice the task time required for one part is taken. Due to issues related to part number, it is preferable to use the following computer device to accurately calculate task time.

This computer device, as shown schematically in FIG. 6, comprises a parts list storage means 70 that stores parts and part quantity to be used in producing a product, a parts-assembly task master storage means 90 that stores, on a by-part basis, task classification for the part, a task time master storage means 92 that stores task time for size and/or weight of part, task classification, and part quantity, and a means 94 for searching for the task time master storage means 92, using as keys the part and part quantity stored in the parts list storage means 70 and the task classifications searched from the parts-assembly task master storage means 90. The means 94 determines task time based on task classification and part quantity.

According to this computer device, an accurate task time for the number of parts to be used can be calculated.

The sizes and/or weights of the parts are preferably stored in association with the parts in one of or both of the parts list storage means 70 and parts-assembly task master storage means 90.

In this situation, once the parts list is arranged in the parts list storage means 70, the task time master storage means 92 can be referred to in order to accurately calculate task time.

Another computer device of the invention comprises a parts list storage means that stores parts and part quantity to be used in producing a product, a parts-assembly task master storage means that stores task for assembling the part and task time of the task and part quantity of the part, and a means for searching for the parts-assembly task master storage means with the part and part quantity stored in the parts list storage means as keys and determining task time.

According to this device, an accurate task time can be calculated for the number of parts to be used.

According to the invention, task and task time required for producing a product can be quickly determined by arranging the parts list in the storage means. As a result, the process of planning a task assignment can be initiated when the parts list is decided on, and the duration from the completion of product design to the start of mass production can be greatly shortened.

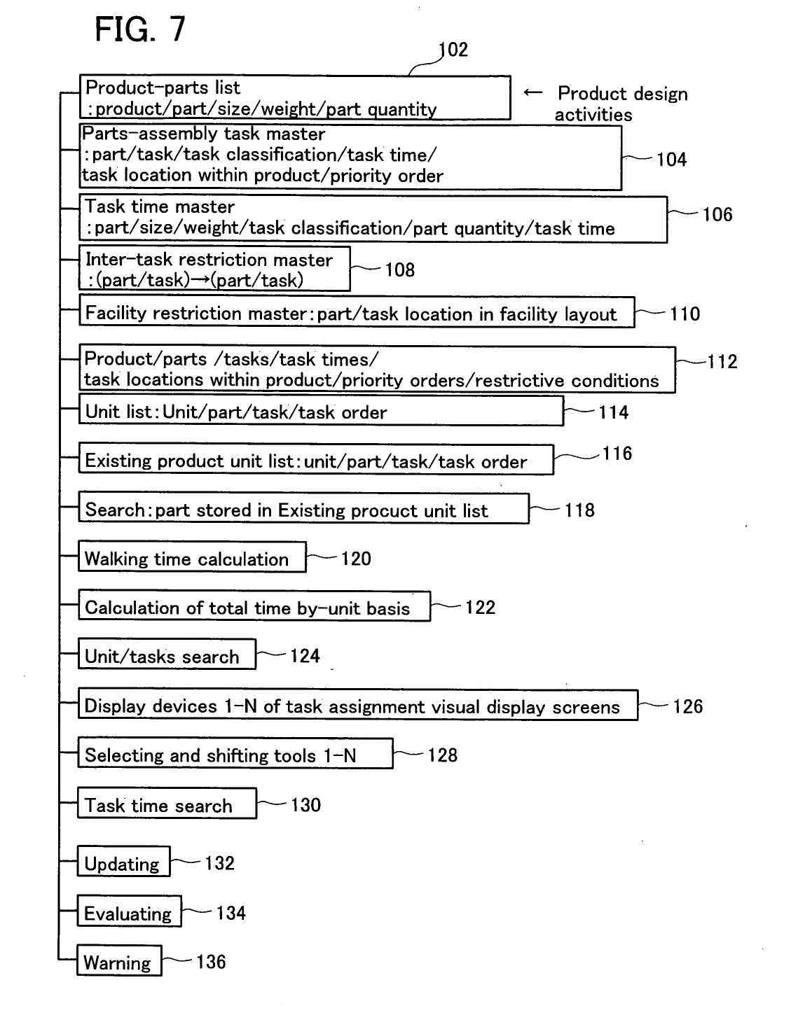

The preferred embodiment of the invention will be discussed in greater detail with reference to the drawings. FIG. 7 is a block diagram of a computer system constituting a support device for planning a task assignment that uses task assignment visual display screen. A description of a hardware configuration of the computer system is omitted because it is a standard computer system that comprises a computing device, a storage device, a display device, a display control device, inputs and outputs devices, and other devices. The following various lists are stored in the storage device of the computer system.

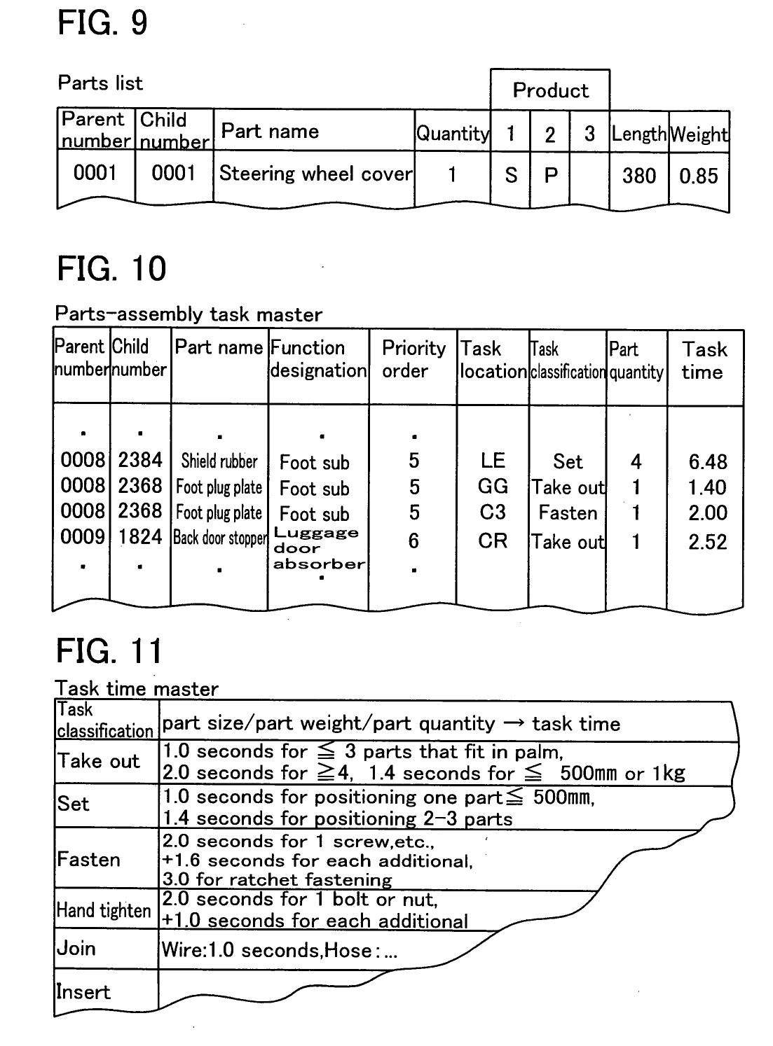

Product-part list 102; stores a list of the parts necessary for producing a product. Part size and/or part weight, and quantities of the part for each product are stored for each part. The part list is stored for each product. One example is shown in FIG. 9, wherein each individual part is designated by a combination of a parent number and a child number. The symbol S in the table means that the part is used as a standard in “product 1”. The symbol P means that the part is used optionally in “product 2”. The null symbol at “product 3” means that the part is not used in “product 3”. Here, “optionally” refers to parts that are used or not used according to customer preference. Information on the length, weight and quantity of the part used for each product is stored in association with each part. This information is referred to when calculating task time of the task in which the part is assembled. The name of the part is stored in association with each part, facilitating comprehension by the planner. Product-part list 102 is given from product design activities.

Parts-assembly task master 104 (FIG. 7), stores, for all parts that are assembled in the production facility in question, a part, a task ID designating the task in which the part is used, the task classification, the task time, the task location within the product, and priority order of each part. The priority order is given in accordance of part function. Each part is classified into one of the functions of the product. The functions are broadly classified. When there are restrictions on inter-task order, all information up to that order restriction is also stored therein.

Generally, a plurality of tasks corresponds to a single part. For example, when a part is taken from a shelf for storing parts, set on a work, and fastened to the work, three tasks would correspond to that part. In that case, three task IDs would be stored for that one part. The task ID is an ID that identifies which task is being referred to from among the thousands of tasks, and a task assignment is denoted by associating task IDs with units.

The task classification is a broad categorization of the type of task. Some examples are shown in the left column of FIG. 11. Tasks can be classified at the level describing whether they involve taking out, setting, fastening, hand tightening, joining, or inserting.

The task location within the product is information that indicates where the task is performed within the product (an automobile in this case). Task locations, as the examples in FIG. 15 show, are denoted as two-character codes. An automobile's front half is represented on the right half of FIG. 15, in which automobile sites are divided into 26 divisions.

The task time master 106 (in FIG. 7); is used to calculate task time from a part. The task time master, an example of which is shown in FIG. 11, is a database from which task time can be obtained by specifying the task classification, the part size and/or part weight, and the quantity of the part. For example, a task involving the taking out of a part that can fit in the palm of the hand would take 1.0 seconds if there were three or fewer of that part and 2.0 seconds if there were four or more of that part. The taking out of a part that is no more than 500 mm in length or 1 kg in weight would take 1.4 seconds. The task time master 106 stores the standard task times required for task classification, part size and/or pat weight, and part quantity. The task time master 106 can be referred to as a database that states in a general manner the relationship between generally occurring tasks and task time.

As is shown in FIG. 9, information indicating part size, part weight and part quantities are stored in the product-part list (102 in FIG. 7), and as is shown in FIG. 10, information indicating task classifications is stored in the parts-assembly task master (104 in FIG. 7), so task times can be calculated by referring to the task time master 106 in FIG. 11 with these parameters as keys. Task times thus calculated in this manner are stored in the parts-assembly task master 104 as shown in FIG. 10. The use of the task time master 106 eliminates the need to measure task time by individual task and allows the simple determination of highly accurate task times.

Information indicating the length and weight of parts can be stored in either the product-part list of FIG. 9 or the parts-assembly task master of FIG. 10 or can be stored in both.

Parts are closely related to product function. The research of the inventors revealed that it is preferable not to allocate tasks to a unit in an unordered manner but rather to associate them with respect to their functions within the product. In the case of automobiles, it is preferable that the assembly of exhaust-related parts, for example, be fully completed with one or a plurality of units and that the assembly of braking-related parts, for example, be fully completed with another unit or plurality of another units. By doing so, worker morale is boosted, inspection unit can be allocated in a streamlined manner so that inspection can be made just after completing the assembly for each function, and high-quality products can be continuously produced in a stable manner. When tasks are grouped with respect to the function of the corresponding parts as above, the order of assembly on a by-function basis becomes important. When products are produced in an appropriate priority order, high-quality products can be produced without difficulty or waste, while difficulty and waste arise when production occurs in another priority order.

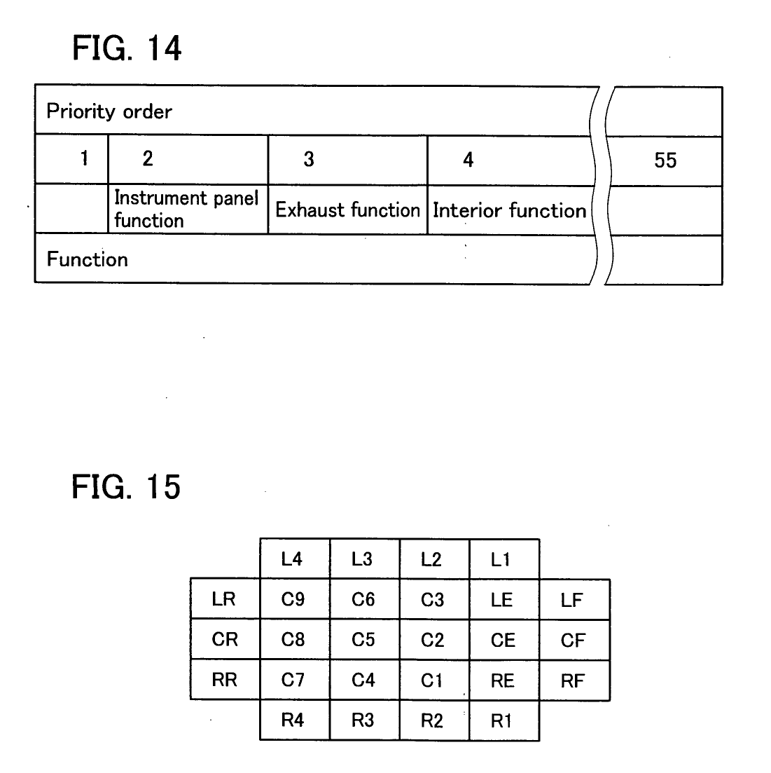

Thus, when parts are classified by their broadly classified functions, a priority order of the task is given to each part and task. Task assignment following the appropriate priority order enables high-quality production without difficulty or waste. An example of which is shown in FIG. 10. Giving the priority order appropriately using previously accumulated know-how leads to a streamlined task assignment that enables high-quality production without difficulty or waste. An example is shown in FIG. 14. In the case of automobiles, if the function of the automobile is divided into 55 categories, it was found that assembly tasks for each category could be completed without interfere with another assembly tasks for another category, and high-quality production could be continued without difficulty or waste. The optimal order of assembly tasks for each category, that is, the optimal priority order can be learned through experience and know-how accumulated over the past. In the case of automobiles, it has been found that production with the least amount of difficulty and waste is possible when tasks associated with instrument panel function are completed before the tasks associated with exhaust function are begun and the tasks associated with exhaust function are completed before tasks associated with interior function are begun. As this know-how is stored in the parts-assembly task master 104, the task assignment planner can draft a plan of task assignment while capitalizing on past know-how.

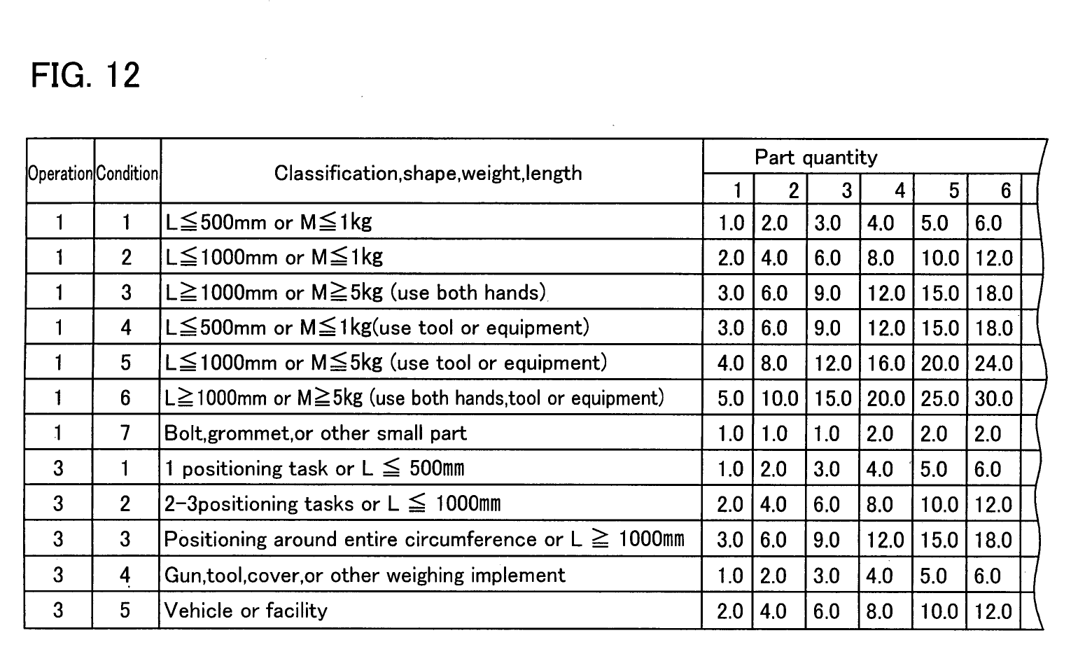

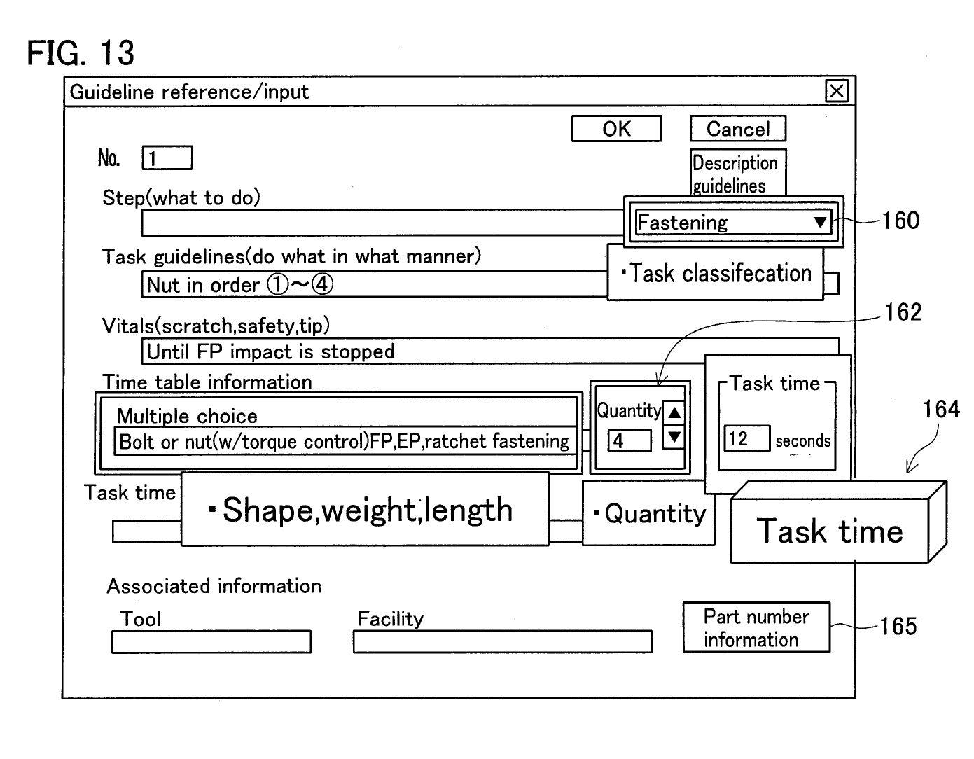

The task time master 106 shown in FIG. 7 is presented in FIG. 11. Another example of a task time master is shown in FIG. 12. It allows the searching of task time by task classification (indicated with an operation number), part size and/or part weight, and quantity of part. FIG. 13 shows an input screen for automatic searching of task times. Task classification is selected (cell 160), the part number is entered (cell 165), part quantity is entered (cell 162), then the task time master 104 is searched, and the searched task time is displayed (cell 164).

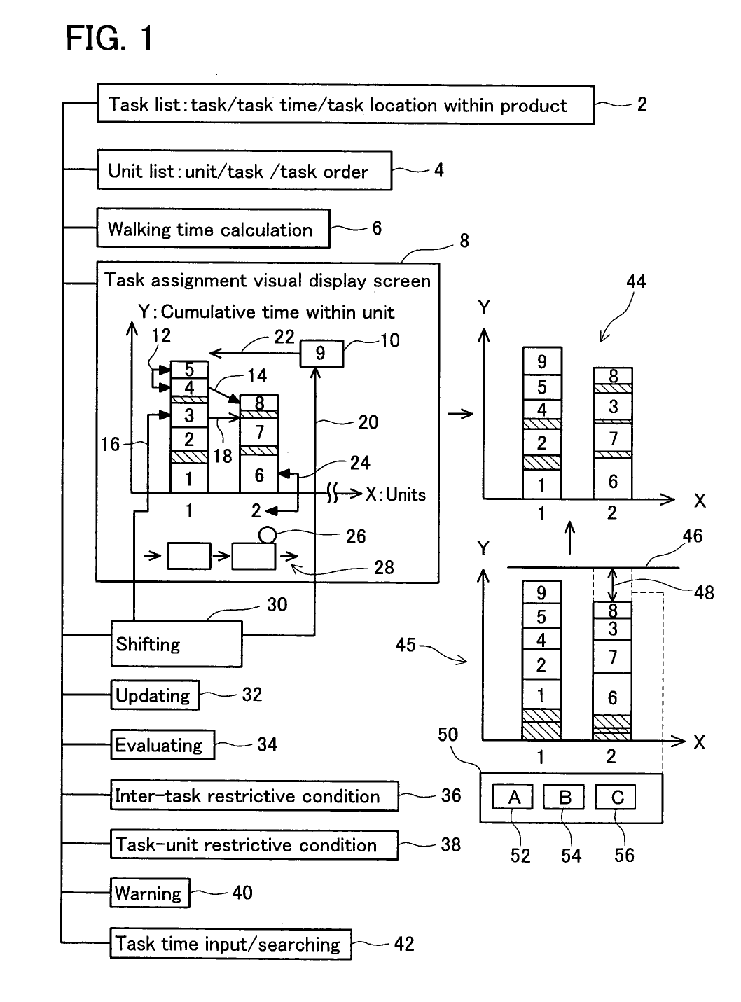

An inter-task restriction master 108, shown in FIG. 7, stores, for example, inter-task restrictive conditions such as whether or not a task cannot be performed until another task has been completed. One example of inter-task restrictive condition “task 4 must be performed before task 8,” is shown by arrow 14 in FIG. 1. The inter-task restrictive conditions may be, for example, such that two tasks must be performed in the same unit. An example of “task 4 and task 5 must be performed in the same unit,” is shown by arrow 12. These restrictive conditions are accumulated in the inter-task restriction master 108 as the planner inputs information. When inter-task restrictive conditions are stored in the parts-assembly task master 104, the information is also stored in the inter-task restriction master 108.

A facility restriction master 110, shown in FIG. 7, stores restrictive conditions as to task location within the production facilities with respect to parts and tasks. “Task 6” shown as an example in FIG. 1, for instance, is a task that uses the stationary facility 26, so the restrictive conditions specifying that “task 6” must be performed in “unit 2” is stored in the facility restriction master 110. These restrictive conditions are accumulated in the facility restriction master 110 as the planner inputs information.

A unit list 114 (FIG. 7) stores part IDs, task IDs allocated to each worker or unit and task order within each unit. It stores part IDs and task IDs and task order within the unit on a by-unit basis. The unit list 114 defines task assignment and it is the final goal to decide the content of the unit list 114. The content of the unit list 114 is provisionally decided during the course leading up to finalization, and elements that cannot be calculated unless a decision is made, such as the calculation of walking time, can be calculated based on the provisional decision. Task location and task order information is necessary to calculate walking time, and task order information is not finalized until task assignment is decided on. This being the case, task assignment cannot be planned in reference to walking time. The current technology adopts a methodology in which task order is provisionally decided on, walking time is calculated based thereon, then task order is corrected based on the results of this calculation, and the task assignment stored in the unit list 114 is thereby updated and improved.

An existing product unit list 116 storage means stores the unit list determined for existing products that were already in production. The unit list 116 stores, by-unit basis, parts, tasks and task order for the existing products. Parts for use in association with tasks are defined in the existing product unit list 116 and the unit list 114.

A searching means 118 searches for parts stored in the existing product unit list 116, using as keys, parts for a new product stored in the product-part list 102, and stores the parts thus found in the unit list 114. At this time, same parts and same tasks are assigned to the same unit and same task order is given as stored in the existing product unit list 116. As a result, in the case of parts and tasks associated with new product for which a task assignment is to be planned, a task assignment is provisionally proposed for common parts and tasks between old products and new product, such that the same units and same task orders are assigned as the existing products.

At this stage, only parts and tasks common to both the new product and existing products are stored in the unit list 114. FIG. 19(B) shows the visual display that is displayed in this stage and shows a visual display of task assignment made up of tasks 1a, 1b, 1d, 1e, 1f, 1h, 1i, 1j, 1k, and 1l, which are common to an existing products and new product.

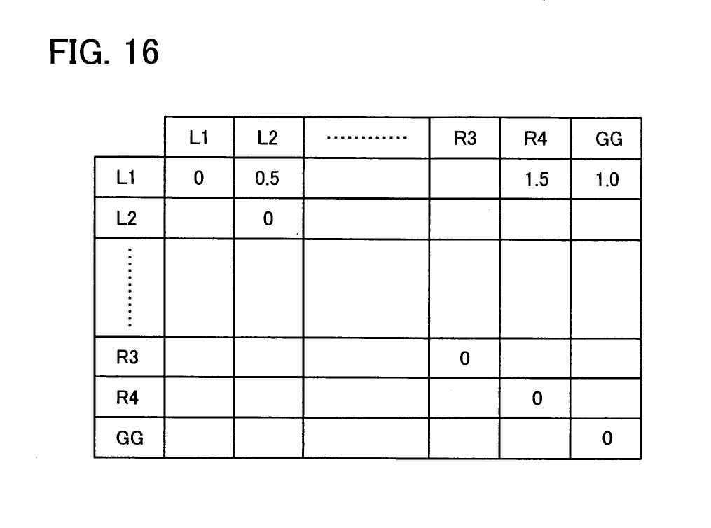

A walking time calculation means 120 (FIG.7) calculates the walking time between task locations from information on task location within the product of successive tasks. FIG. 16 shows a map to which the walking time calculation means refers. Task locations within the product (see FIG. 15) are presented on the vertical and horizontal axes. It can be seen that if the task location of a first task is L1 and the following task location is L2, the walking time of the worker is 0.5 seconds. The product is conveyed by a conveying device, so the actual walking time differs depending on whether the worker walks in a direction identical or opposite to the conveying direction. As such, the walking times of FIG. 16 are corrected based on the conveying speed of the product and walking direction to determine the actual walking time. Walking times also differ depending on whether the product's (an automobile in this case) door is open or closed; so two types of the map in FIG. 16 are prepared. A provisional task order stored in the unit list 114 is used to identify successive tasks.

A calculation of total time by-unit basis means 122 (FIG.7) calculates the task time in a unit by totaling the task times and walking times required when the tasks stored in the unit list 114 are performed in the stored task order.

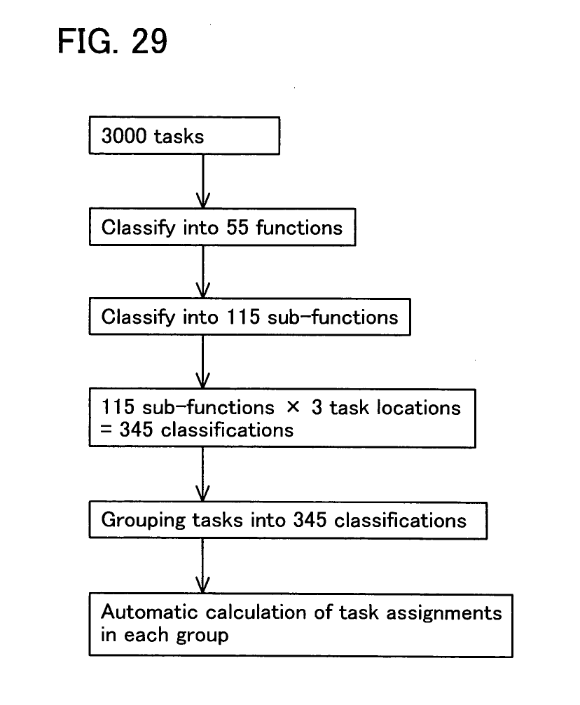

A unit/tasks searching means 124 (FIG.7) is used when a new production line is being planned and automatically calculates task assignment in accordance with FIG. 29. As is shown in FIG. 14, the functions of an automobile can be classified into 55 functions in the case. They can actually be classified in a bit more detail into 115 sub-functions. These 115 classifications can be classified into 345 groups by classifying them into tasks at the left side, tasks at the center, and tasks at the right side of the automobile. The tasks, which number about 3000, can be grouped into the 345 groups, and when they are, about 10 tasks belong to each group. If there are only about 10 tasks, a candidate of task assignment that makes for a roughly equivalent total time for each unit can be automatically calculated with the computer system.

The unit/tasks searching means 124, when allocating a relatively small number of tasks to a relatively small number of units, executes a process in determining a task assignment with a total time for each unit being fit within the specified time range. The unit/tasks searching means 124 automatically calculates and discovers a candidate of the task assignment.

When a new product is placed in an existing production facility, task assignment for the common parts and common tasks is provisionally decided on by the searching means 118 and stored in the unit list 114. In the case of a new production facility, task assignment, capitalizing on past know-how, is automatically calculated by the unit/tasks searching means 124, and the automatically calculated task assignment is stored in the unit list 114.

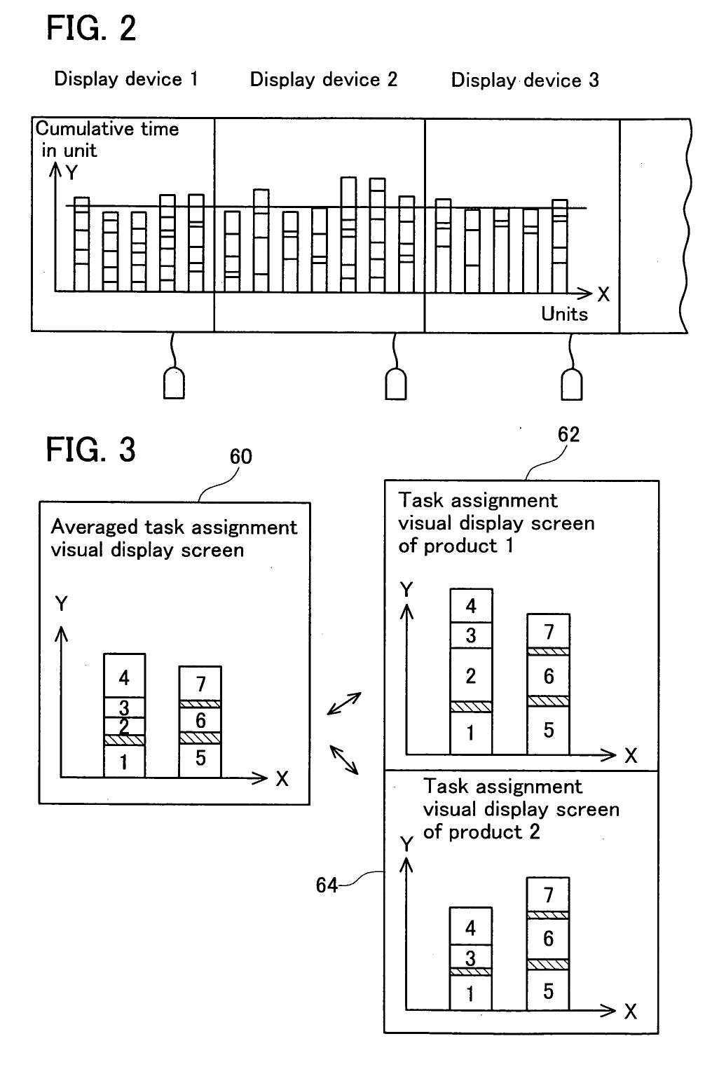

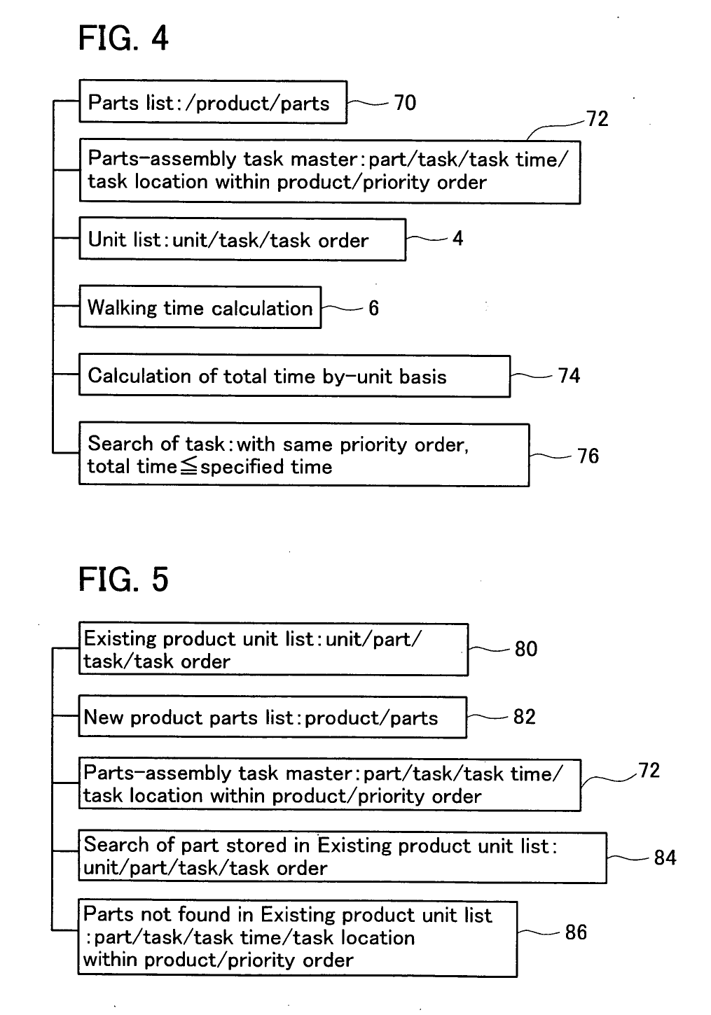

When tasks (therefore parts and task times) and task order are stored in the unit list 114, the task assignment visual display screen is displayed in the display device of the computer system. In actuality, there are a large number of units, so as is schematically shown in FIG. 2, two or more display devices aligned continuously are used for display (126 in FIG. 7).

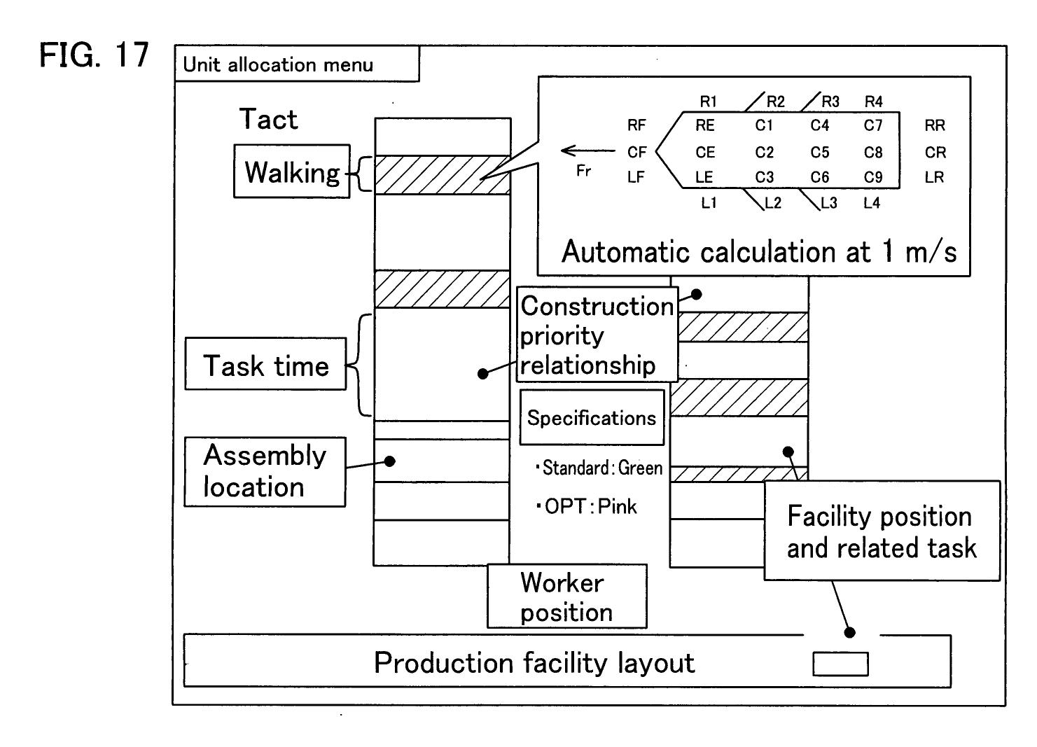

FIG. 17 shows a partially expanded view of the task assignment visual display screen, and one vertical column corresponds to one unit. The vertical-axis indicates the passage of time from bottom to top, and the tasks proceed from bottom to top in each unit. The task times and walking times are cumulatively calculated in accordance with the task order in each unit and clearly displayed in the Y-axis (vertical-axis) direction.

In the task assignment visual display screen, length in the Y-axis direction indicates time, and task order is indicated as the order in the Y-axis direction. Progress in tasks is displayed as stacked blocks.

In the task assignment visual display screen, inter-task restrictive conditions (in FIG. 17, a straight line with an indication of “construction priority relationship” is drawn between two tasks for which order is restricted due to constructing priority in order to indicate that their order is restricted), restrictive conditions between task and unit (in FIG. 17, a straight line with an indication of “facility position and related task” is drawn between a stationary facility and a task whose task location is restricted due to the location of the stationary facility in order to indicate that task location is restricted), workers position, and task specifications are displayed. The production facility layout is also displayed in the lower cell in association with units. Blocks that indicate walking time (shown with diagonal lines) are incorporated into the task time blocks display.

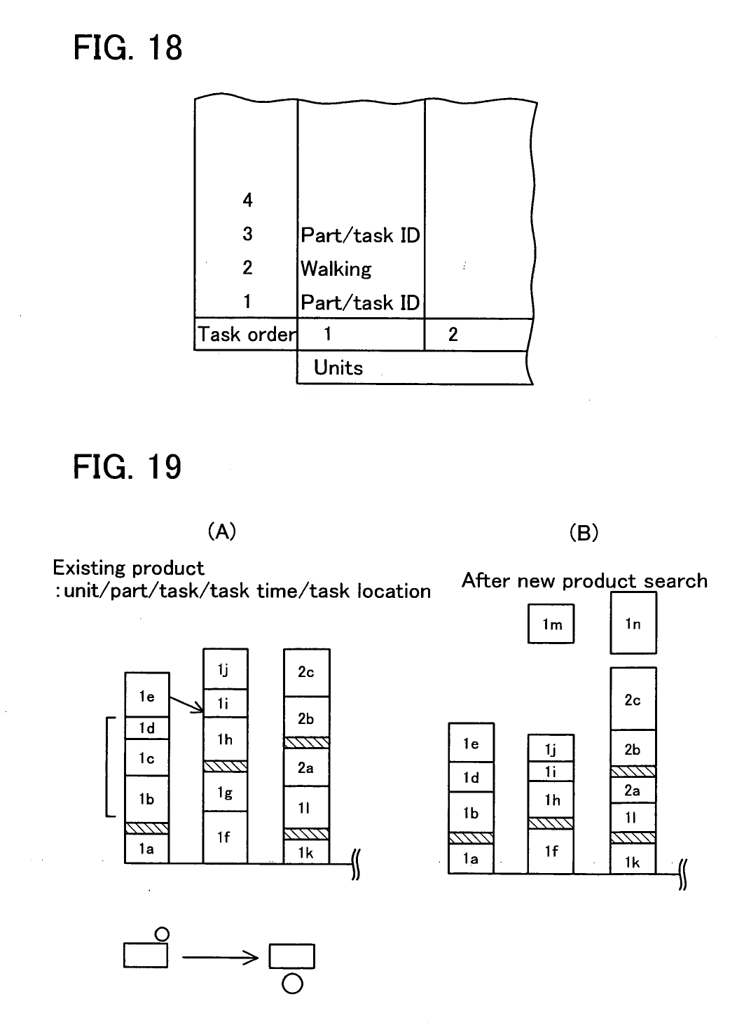

FIG. 18 schematically shows the content stored in the unit list 114. The task IDs are indicated in association with unit and task order. Walking tasks are not stored as independent tasks. When successive tasks have different task locations, walking time is displayed on the task assignment visual display screen.

FIG. 19(A) shows an example of the task assignment visual display screen displayed based on the contents stored in the existing product unit list 116. It also displays relationships specifying that tasks 1b to 1d must be performed in the same unit and task 1e must be performed before task 1i.

FIG. 19(B) shows an example of task assignment visual display screen for a new product. In order to display the task assignment visual display for the new product, the necessary parts for the new product are searched from product-parts list 102. Then the existing product unit list 116 is searched and the necessary parts for the new product are divided into two groups. The first group includes parts that were already used for existing products. The second group includes parts that are not used for existing products. The corresponding tasks for the parts in the first group are found from the part-assembly master 104 and found tasks are given the provisional task order. The provisional task order will be the same as stored in existing product unit list 116. In FIG. 19 (B), the parts corresponding to the tasks 1c and 1g are not used for the new product, and task blocks 1c and 1g are deleted. The parts corresponding to the task 1a, 1b, etc. are used both in the existing products and the new product, therefore, the corresponding tasks blocks are indicated as the same order in FIG. 19(A). The parts corresponding to tasks 1m and 1n are not used in the existing products but used in the new product. The corresponding tasks blocks 1m and in are indicated in FIG. 19(B). The height of the tasks blocks 1m and 1n determined from the part-assembly task master. However, the unit and task order are not assigned to the tasks 1m and 1n, therefore, the positions of tasks blocks 1m and in are deferent from the tasks blocks whose unit and task order are already assigned.

Here, the preceding character in the symbol specifying the tasks is the priority order when the production steps or product functions are broadly classified. The display indicating tasks 1m and 1n, which are not yet associated with the unit, is presented in the location corresponding to the unit having priority order “1”, so the task assignment planner can find the tasks that need to be allocated near the task group blocks having the same priority order.

The symbols that indicate tasks that are not yet associated with the unit can thus be incorporated in the block expression and associated with the unit through so-called click-and-drop operation with the mouse.

The selecting and shifting tools 1-N (128) in FIG. 7 refer to screen operation tools such as the mouse. They are used to select a certain task in the task assignment visual display screen and move it to a desired location.

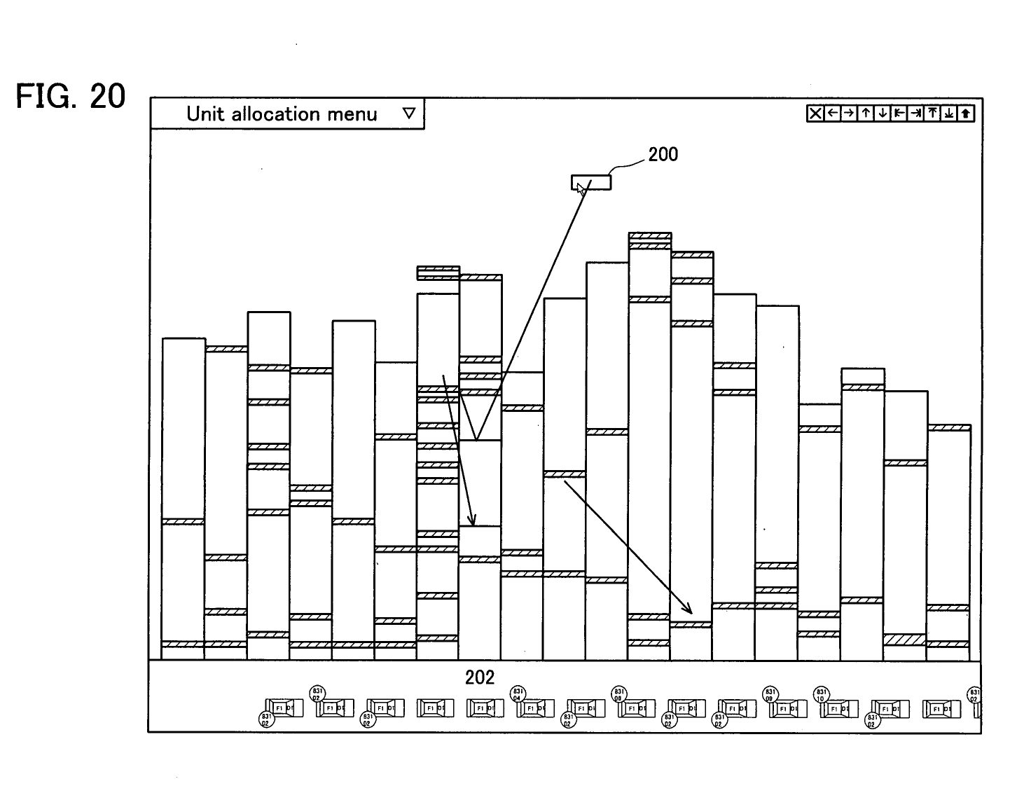

FIG. 20 shows an example that task 200 is selected and removed from unit 202 in the task assignment visual display screen. The planner can drop this selected task 200 at a desired location.

Once it is dropped, the content stored of the unit list 114, the example is shown in FIG. 18, is updated. An updating means 132 (FIG. 7) is provided for this purpose. Once the content stored in the unit list 114 is updated, it is changed to correspond to the task assignment visual display screen following the task movement. When walking time changes due to the movement of the task, walking time is either shortened or extended and corrected walking time is shown on the task assignment visual display screen. When walking is rendered unnecessary or created due to the task movement, the display is corrected corresponding thereto.

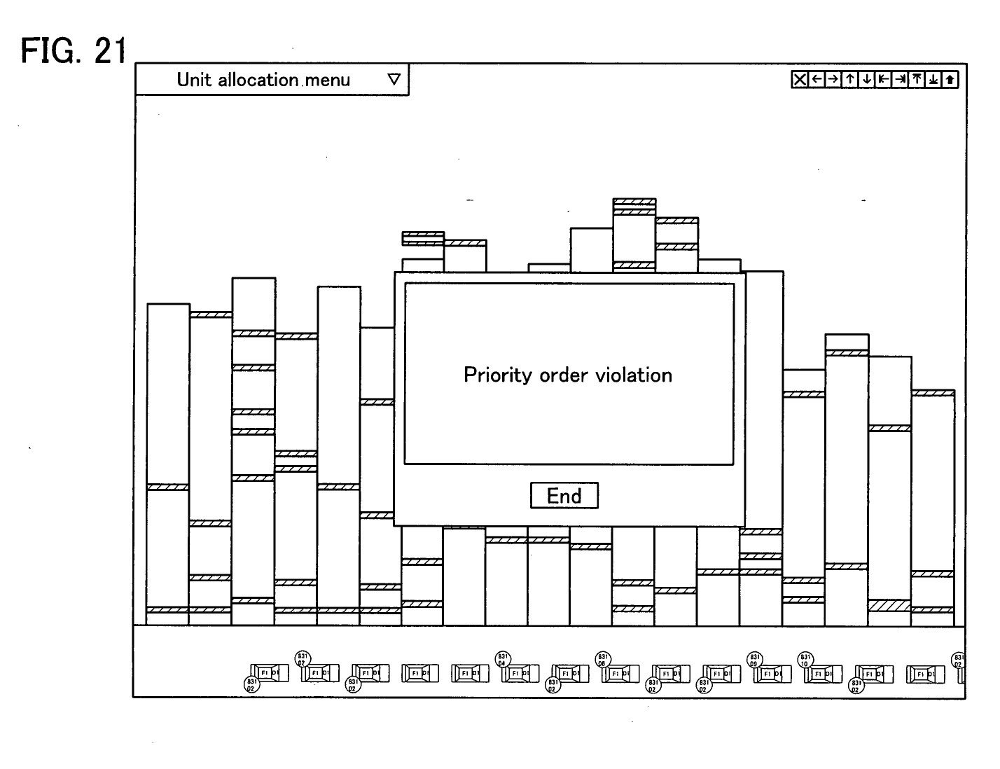

Should a restrictive condition stored in the inter-task restriction master 108 or the facility restriction master 110 be violated due to the task movement, the computer system detects this violation and issues a warning. A warning means 136 is provided for this purpose. FIG. 21 shows a warning screen. A priority order has been violated due to the task movement, so the screen warns that the movement is not allowable.

A task time searching means 130, shown in FIG. 7, is a means that provides information to the planner. When the task assignment planner specifies a task time, the computer system searches for the parts-assembly task master 104 and identifies tasks having task times near the task time input, and displays them.

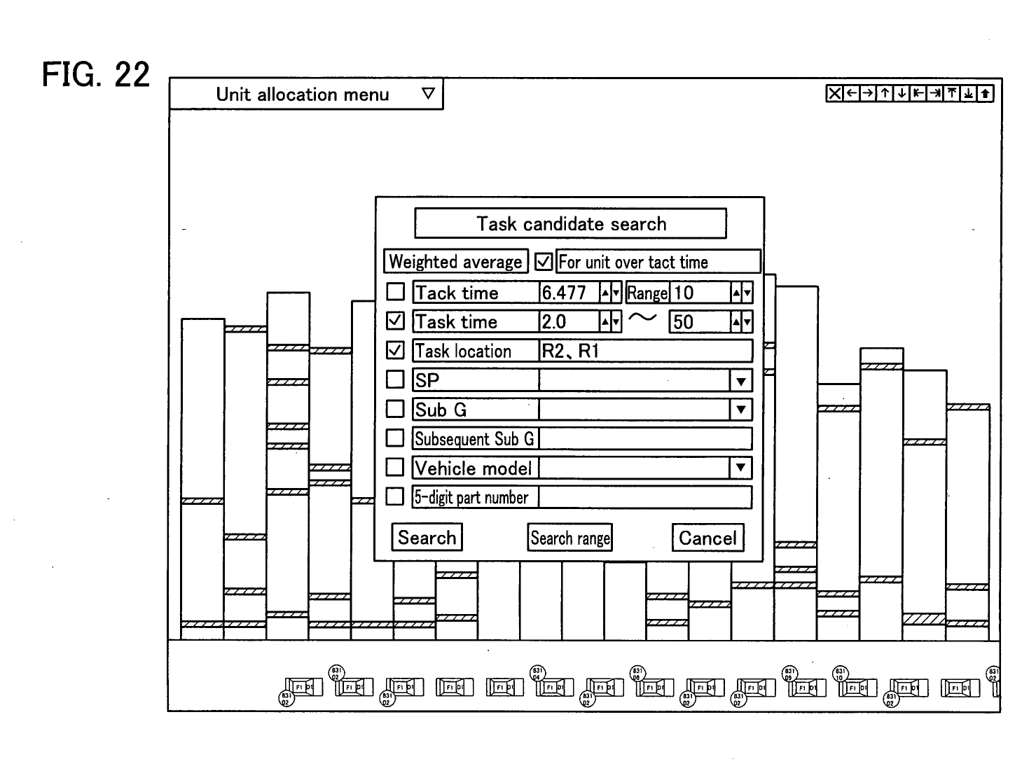

FIG. 22 shows the input screen during a search. The computer system begins the search when the search criteria are input and the search button is clicked on.

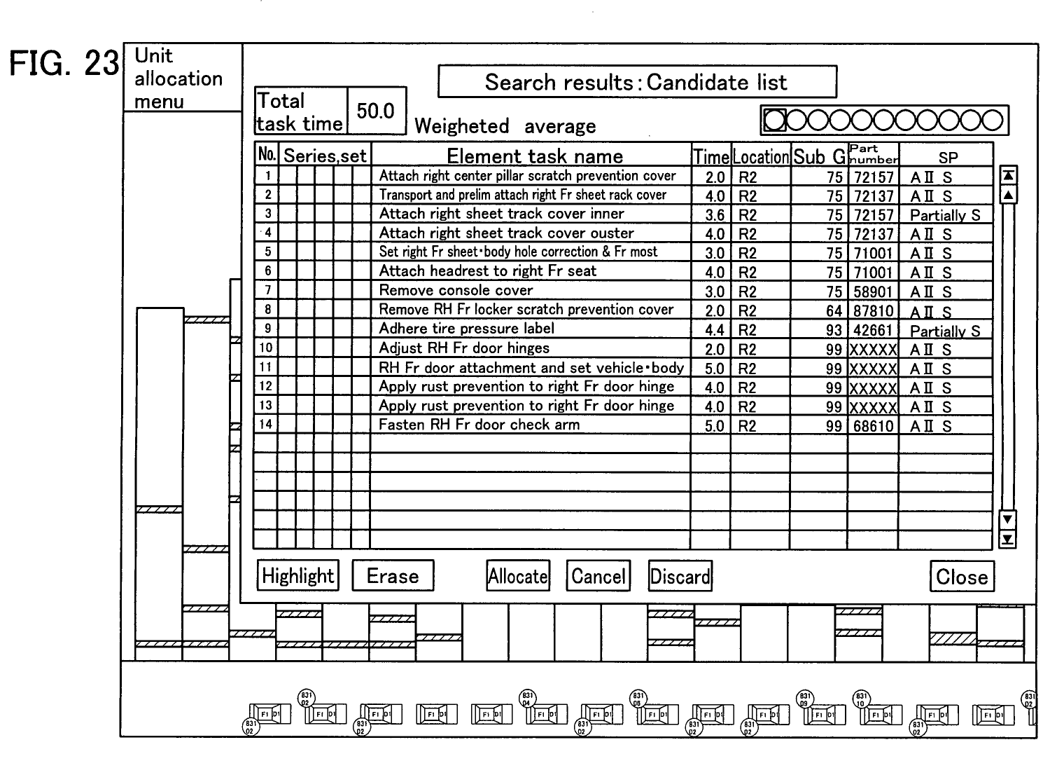

FIG. 23 shows an example of a tabular display of search results. It shows an example situation in which several tasks fulfilled the search criteria.

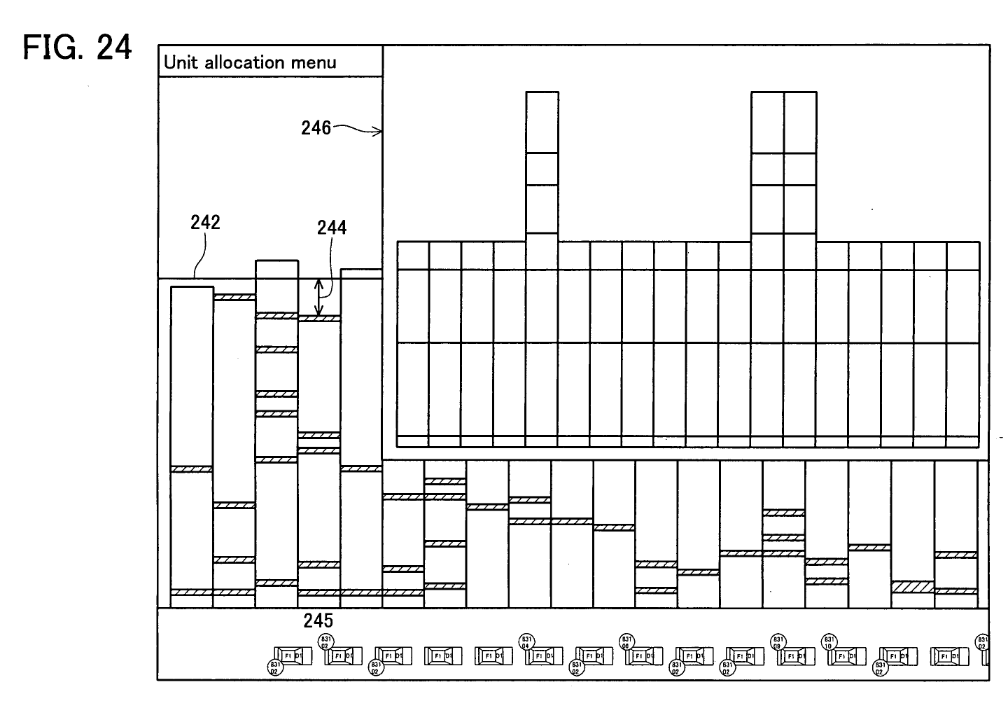

Using this searching function, the planner can discover candidate of tasks that might, for example, be appropriate for allocation to unit 245, which has less task times by 244 than the tact time 242 in FIG. 24.

When the task searched for this purpose is a task that is displayed on another display device, a display screen 246 of that other display device can be displayed on the display device currently in use. The use of this function allows a task to be moved between units separated by a great distance.

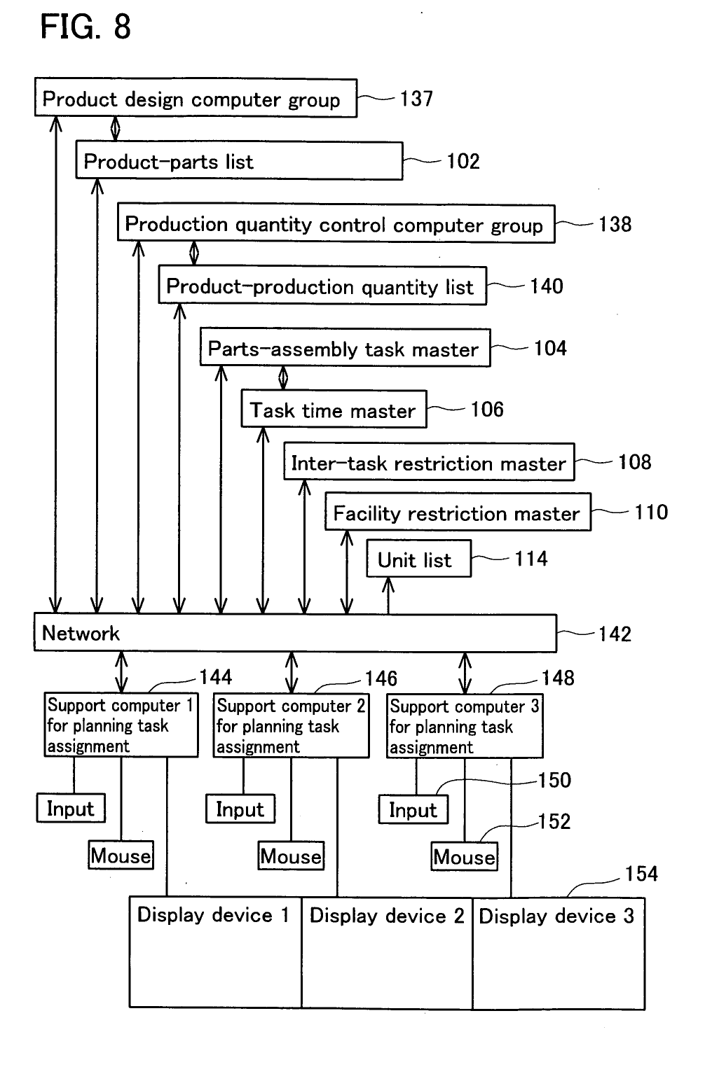

FIG. 8 shows a computer system group network. The support system for planning task assignment can be configured by connecting a plurality of computer systems 144, 146, and 148 with a network 142. The computer systems 144, 146, and 148 function as support terminals for planning the task assignment, obtain information from product-parts list 102, parts-assembly task master 104, task time master 106, inter-task restriction master 108, and the facility restriction master 110, and update unit list 114. An input terminal 150 such as a keyboard, a screen control terminal 152 such as a mouse, and a display device 154 are connected to the computer systems 144, 146, and 148.

A product design computer group 137 is connected to the network 142, and the support system for planning task assignment obtains product-parts list 102 from the product design computer group 137 and stores it in the product-parts list 102. Additionally, a production quantity control computer group 138 is connected to the network 142, and the support system for planning task assignment obtains information about what product is to be made in what volume at what time from the production quantity control computer group 138, and stores this in a product-production quantity list 140.

According to the support system for planning task assignment of this embodiment, when a new product is placed in an existing production facility, task assignment for the common parts and common tasks is preliminarily decided on by the searching means 118, stored in the unit list 114, and displayed on the visual display of FIG. 19(B). In FIG. 19(B), task assignment for an existing product is passed along in the case of parts and tasks common to that existing product and the new product, and task time or other information is displayed for parts and tasks unique to the new product without associating them with the unit. This allows the task assignment planner to know at a glance the tasks that are to be allocated, and as there is a display showing the tasks that are to be incorporated near the units they are to be incorporated into, the task assignment planner can in a short time draft a task assignment that does not conflict with that of the existing product.

In the case of a new production facility, task assignment capitalizing on past know-how is automatically calculated by the unit/tasks searching means 124 (FIG.7), the automatically calculated task assignment is stored in the unit list 114, and the automatically planned task assignment is visually displayed.

The task assignment planner, while watching a visual display created under some method, can use the mouse to allocate unallocated tasks into appropriate units and move the tasks with some problems to units with no problem in order to improve the task assignment to a streamlined one. As this process is visually shown, the process of streamlining the task assignment is vigorously supported by the computer system to allow a task assignment lacking difficulty or waste to be drafted in a short time.

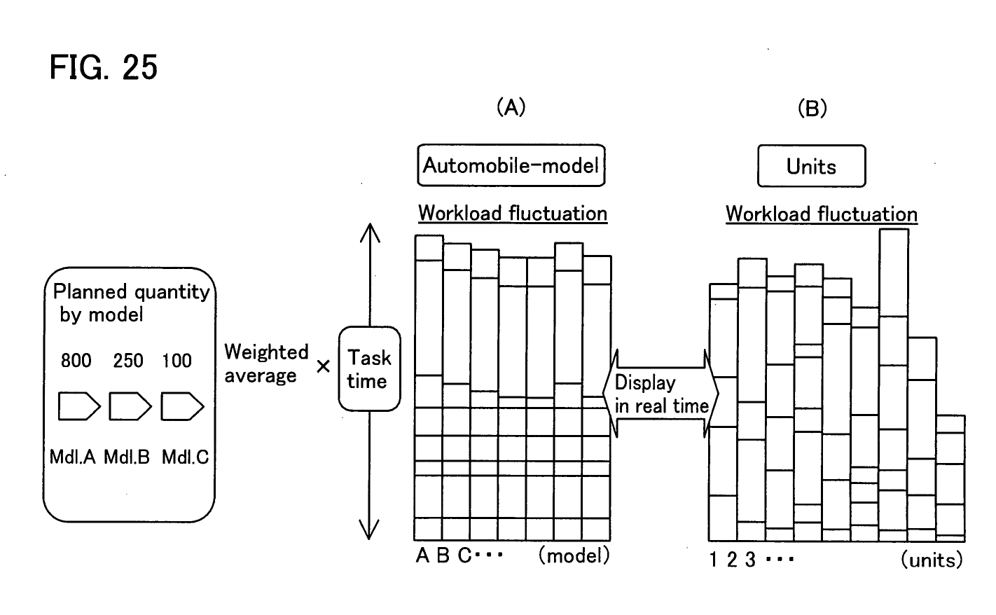

In the support device of this embodiment, there are provided with various tools for visually grasping the degree of difficulties and waste present in a task assignment. FIG. 25(A) illustrates a display that divides up task times in a specified unit on the basis of product models in the case of the mixed production of product models A, B, and C. It is quickly apparent that the workload in the unit is high during the production of model A. FIG. 25(B) illustrates fluctuations in the average task time on a by-unit basis during the mixed production of 800 units of product model A, 250 units of product model B, and 100 units of product model C, showing that there is a greater workload in unit 2 than unit 1. The average task time for each unit is a weighted average. Given that TA is the task time for product A, TB is the task time for product B, and TC is the task time for product C, the average task time is calculated as TA×800/1150+TB×250/1150+TC×100/1150.

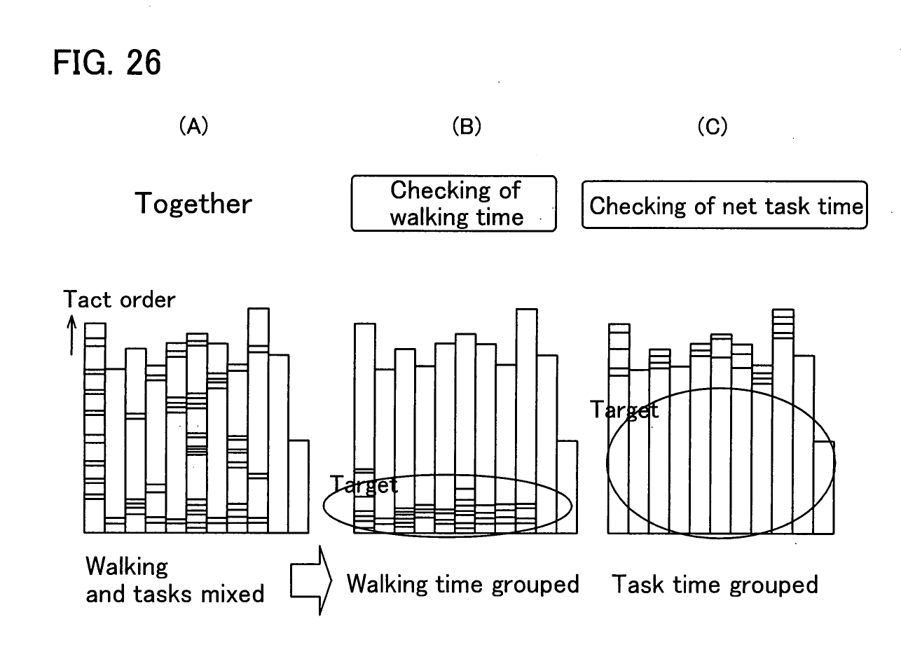

FIG. 26(A) shows a visual display presented in the task order within the unit. FIG. 26(B) shows a display with walking times grouped together at the bottom, and (C) shows a display with the task times of actual task times grouped together at the bottom. The total walking time in a unit is visually ascertained from (B), and the total task time is visually ascertained from (C). The use of these switchable displays allows the visual evaluation of whether or not a task assignment with no difficulty or waste has been planned.

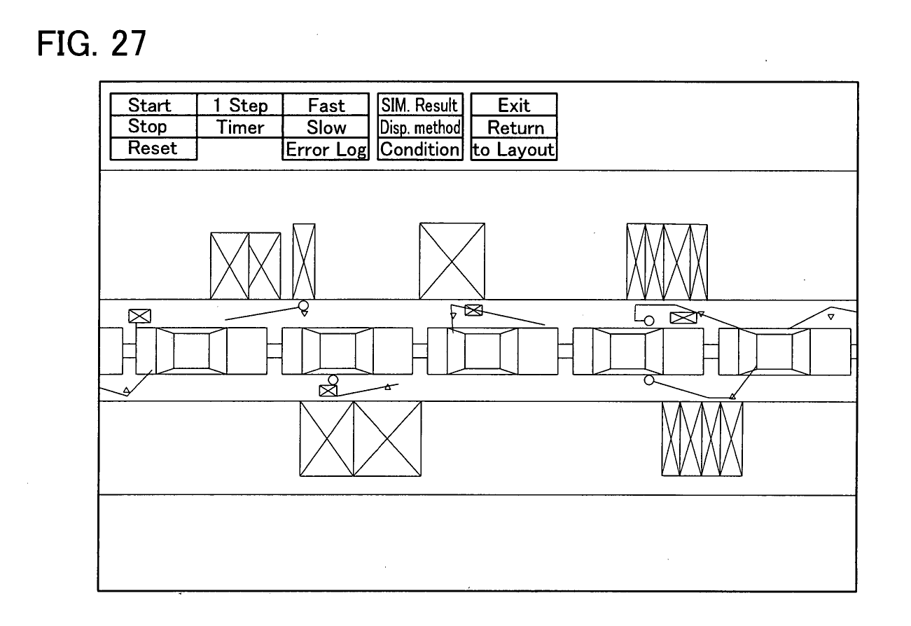

FIG. 27 shows one example of a screen that displays an animation of worker movement during tasks in accordance with the task assignment after the task assignment has been finalized. The use of this animated display provides for a check of possible interference between workers in advance.

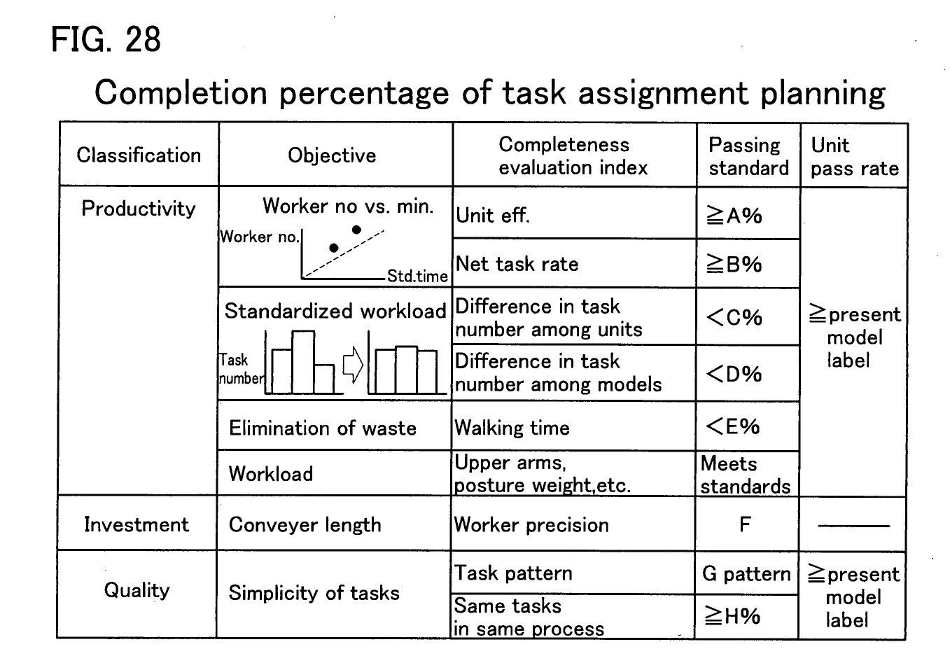

A program that evaluates proposed task assignment is provided in the task assignment planning support device of this embodiment. FIG. 28 shows an example of the results of an evaluation—assessments from a variety of standpoints are shown, and assessment categories that fall below a passing rate are highlighted. It has been confirmed that task assignment assessed as good evaluation is also satisfactory under actual conditions.

Although a concrete example of the invention has been explained in detail, it is only an example and does not limit the claims. The technology recited in the claims includes various permutations and modifications to the concrete example presented as an example above.

The technical elements described in this specification or the drawings derive their technical utility either independently or in various combinations and are not limited to the combinations recited in the claims at the time of filing. The technologies described as examples in the specification or drawings simultaneously attain a plurality of objects and possess technical utility in the attainment of any one of those objects.

1. A device for supporting a process of allocating tasks to each unit of a production line in which a plurality of tasks is performed in each unit and a plurality of units is provide along the production line, comprising:
a task list storing means that stores, on a by-task basis, task time, task location within the product,
a unit list storing means that stores, on a by-unit basis, tasks and task order of each task,
a worker walking time calculating means that calculates walking time from the task order stored in the unit list storing means and the task location stored in the task list storing means,
a means for displaying a task assignment visual display screen that displays task times and walking times along the Y-axis direction in accordance with the task order within the unit at a location of the unit, the units being arranged along the X-axis on the screen,
a means for allowing a planner to specify and shift a certain task on the task assignment visual display screen, and
a means for updating content stored in the unit list storing means in accordance with the result of the shift operation.

2. The support device of claim 1, further comprising:
an inter-task restrictive condition storing means that stores inter-task restrictive conditions, and
a warm issuing means when the result of the task shift violates the inter-task restrictive conditions stored in the inter-task restrictive condition storing means.

3. The support device of claim 1, further comprising:
a means for additionally displaying a symbol that indicates an inter-task restrictive condition on the task assignment visual display screen.

4. The support device of claim 1, further comprising:
a task-unit restrictive condition storing means that stores restrictive conditions between tasks and units,
a means for additionally displaying a production facility layout in association with the units on the task assignment visual display screen, and
a warm issuing means when the result of the task shift violates the task-unit restrictive conditions stored.

5. The support device of claim 1, further comprising:
a means for additionally displaying a tact time on the task assignment visual display screen, and
a means for searching for the task list storing means with a task time entered by a planner as a key and displaying a searched task having a task time close to the task time entered.

6. The support device of claim 1, further comprising:
a means for switching to an integrated task assignment visual display screen that displays the task time or the walking time of each unit in an integrated manner.

7. The support device of claim 1,
wherein a plurality of display devices is continuously arranged for displaying the successive task assignment visual display screen.

8. A computer system comprising;
a means for displaying a task assignment visual display screen in which task time and walking time between tasks are displayed in the Y-axis direction in accordance with task order within a unit at corresponding location to the unit on a screen, the units being arranged along the X-axis.

9. The computer system according to claim 8,
wherein an additional display that indicates a task time with its length in the Y-axis direction of a task not associated with any units is displayed in the task assignment visual display screen.

10. The computer system according to claim 8,
wherein an additional display that indicates a production facility layout in association with units is displayed in the task assignment visual display screen.

11. The computer system according to claim 8,
wherein a planner is allowed to select a certain task on the task assignment visual display screen and shift the selected task in the task assignment visual display screen.

12. The computer system according to claim 8,
wherein either one of a task assignment visual display screen for a specific-product, and an averaged task assignment visual display screen which displays task time and walking time weighted-averaged from products in mixed production in a unit period is displayed.

13. A program comprising:
steps of displaying on a computer display device a task assignment visual display screen in which task time and walking time between tasks are displayed in the Y-axis direction in accordance with task order within a unit at corresponding location to the unit on a screen, the units being arranged along the X-axis.

14. A computer system that supports a process of determining what tasks to be assigned to which units, comprising:
a means for storing a parts list of a product that stores the parts necessary in producing the product,
a means for storing a parts-assembly task master that stores, on a by-part basis, task for assembling the part, task time of the task, task location within the product of the task, and priority order of the task that is determined based on a function of the part,
a means for storing unit list that stores, on a by-unit basis, tasks allocated to the unit and task order within the unit of the task,
a means for calculating worker walking time from the task order stored in the means for storing unit list and the task location within the product stored in the means for storing the parts-assembly task master,
a means for calculating, on a by-unit basis, total time of the task times and the worker walking times within the unit, and
a means for searching a task under conditions that the priority order of the task is same to the corresponding unit and the total time is equal to or less than a specified time, and for storing the searched task to the corresponding unit within the unit list.

15. A computer system that supports a process of determining what tasks to be assigned to which units, comprising:
a means for storing existing product unit list that stores, on a by-unit basis, parts assembled in the unit, tasks allocated to the unit, and task orders of the tasks for products already in production,
a means for storing parts necessary in producing a new product whose production will start,
a means for storing a parts-assembly task master that stores, on a by-part basis, task for assembling the part, task time of the task, task location within the product, and priority order of the task that is determined based on a function of the part,
a means for searching for the existing product unit list using as a key the part for the new product, and determining the unit and task order within the unit for parts commonly used for old products and new product, and
a means for displaying tasks, task time, task location and priority order stored in the means for storing parts-assembly task master of unsearched parts.

16. A computer system that supports a process of determining what tasks to be assigned to which units, comprising:
a means for storing, on a by-task basis, task time of the task,
a means for storing a units list that stores, on a by-unit basis, tasks allocated to the unit and task order within the unit,
a means for displaying a task assignment visual display screen that integrally displays task times along the Y-axis direction in accordance with the task order within a unit at a location corresponding to the unit, the units being arranged along the X-axis,
a means for allowing a planner to specify and shift a certain task on the task assignment visual display screen, and
a means for updating content stored in the unit list storing means in accordance with the result of the shift.

17. A computer system comprising;
a means for displaying a task assignment visual display screen in which task times are displayed along the Y-axis direction in accordance with task order within a unit at a location corresponding to the unit, the units being arranged along the X-axis.

18. A program comprising;
steps pf displaying on a computer display device a task assignment visual display screen in which task times are displayed along the Y-axis direction in accordance with task order within a unit at a location corresponding to the unit, the units being arranged along the X-axis.
